(19) United States
(12) Patent Application Publication
(10) Pub. No.: US 2006/0152157 A1
(43) Pub. Date: Jul. 13, 2006

(54) Plasma display panel

(76) Inventors: Eun-Young Jung, Suwon-si (KR); Gun-Young Hong, Suwon-si (KR)

Correspondence Address: LEE & MORSE, P.C.;Attorneys and Counselors At Law, SUITE 2000, 1101 WILSON BOULEVARD, ARLINGTON, VA, 22209, US

(21) Appl. No.: 11/318,620

(22) Filed: Dec. 28, 2005

(30) Foreign Application Priority Data
Jan. 11, 2005 (KR) 10-2005-0002435

(51) Int. Cl. H01J 17/49

(52) U.S. Cl. 313/582; 313/585

(57) ABSTRACT

A plasma display panel including a plurality of pixels, wherein each pixel includes a white sub-pixel, and the white sub-pixel includes a white phosphor layer, and a plasma display panel including first and second electrodes, wherein each of the first and second electrodes encircles each sub-pixel. Embodiments of the plasma display panel further include a first substrate and a second substrate spaced apart from each other and facing each other, first barrier ribs disposed between the first and second substrates and defining at least four discharge cells corresponding to the red sub-pixel, the green sub-pixel, the blue sub-pixel, and the white sub-pixel, and first and second electrodes.

### BACKGROUND OF THE INVENTION

1. Field of the Invention

The present invention relates to a plasma display panel. More particularly, the present invention relates to a plasma display panel exhibiting a high brightness.

2. Description of the Related Art

FIG. 1 illustrates an exploded perspective view of a conventional alternating current (AC) type three-electrode surface-discharge plasma display panel. Referring to FIG. 1, a plasma display panel 5 may include a rear substrate 10 and a front substrate 20, which face each other. The front substrate 20 may be a transparent substrate, e.g., glass, which can transmit visible light. The front substrate 20 may be coupled to the rear substrate 10 and contain a discharge gas therebetween.

A plurality of address electrodes 11 may be arranged on a front surface of the rear substrate 10 and buried in a first dielectric layer 12. Barrier ribs 13 may be formed on a front surface of the first dielectric layer 12 to partition discharge cells 14, which may be arranged in a matrix configuration. Each of the discharge cells 14, which are defined by the barrier ribs 13, may be coated with a phosphor layer 15 having a predetermined thickness.

Sustain electrode pairs 30 may be formed on a rear surface of the front substrate 20 to cross the address electrodes 11. One of each of the sustain electrode pairs 30 may be an X electrode 21 and the other may be a Y electrode 22. The sustain electrode pairs 30 may be buried in a second dielectric layer 23, which may be transparent. A protective layer 24 may be formed on a rear surface of the second dielectric layer 23.

Significant efforts have been devoted to improving the brightness of such a plasma display panel. For example, the amount of Xe in the discharge gas may be increased to, e.g., 20%. However, in a three-electrode surface-discharge plasma display panel, or in a three-electrode opposite-discharge plasma display panel, as the percentage of Xe in the discharge gas increases, a driving voltage may increase and a discharge response speed may decrease. Further, the high driving voltage may increase a discharge current and may, consequently, decrease the durability of a panel.

### SUMMARY OF THE INVENTION

The present invention is therefore directed to a plasma display panel exhibiting a high brightness, which substantially overcomes one or more of the problems due to the limitations and disadvantages of the related art.

It is therefore a feature of an embodiment of the present invention to provide a plasma display panel including a discharge cell that generates white light.

It is therefore another feature of an embodiment of the present invention to provide a plasma display panel having an electrode arrangement that enables high levels of visible light emission.

It is therefore still another feature of an embodiment of the present invention to provide a large area for discharge.

At least one of the above and other features and advantages of the present invention may be realized by providing a plasma display panel including a plurality of pixels, wherein each pixel includes a white sub-pixel, and the white sub-pixel includes a white phosphor layer.

The white phosphor layer may include a blue phosphor and a yellow phosphor. The blue phosphor may include at least one of a BAM-based phosphor and a CMS-based phosphor. The yellow phosphor may include at least one of a YAG-based phosphor and a (Sr, Ba)SiO₄-based phosphor. Each pixel may further include a red sub-pixel, a green sub-pixel, and a blue sub-pixel. Each of the sub-pixels may have a substantially rectangular shape. Each of the sub-pixels may be square, and the sub-pixels may be arranged in a square.

The plasma display panel may further include first and second electrodes, wherein each of the first and second electrodes encircles each sub-pixel. Each of the first and second electrodes may have a ladder shape and include two long members and a plurality of short members, the short members spaced apart from each other and disposed between the two long members, and each sub-pixel may be bounded by the two long members and two short members. Adjacent sub-pixels may be bounded by a common short member.

The plasma display panel may further include a first substrate and a second substrate spaced apart from each other and facing each other, first barrier ribs disposed between the first and second substrates and defining at least four discharge cells corresponding to the red sub-pixel, the green sub-pixel, the blue sub-pixel, and the white sub-pixel, and first and second electrodes. Each of the first and second electrodes may extend to surround the discharge cells. Each of the first and second electrodes may have a ladder shape. The first and second electrodes may be disposed in the first barrier ribs. The plasma display panel may further include protective layers formed on sidewalls of the first barrier ribs. The first electrodes may extend in a first direction, and the second electrodes may extend in a second direction crossing the first direction. The first and second electrodes may extend parallel to each other in a first direction, and address electrodes may extend in a second direction crossing the first and second electrodes.

The plasma display panel may further include second barrier ribs disposed on the second substrate and between the first barrier ribs and the second substrate. Portions of the second barrier ribs may be coated with red, green, blue, and white phosphor layers corresponding to the red, green, blue and white sub-pixels. The pixels may have square shapes.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of a conventional alternating current (AC) type three-electrode surface-discharge plasma display panel;

FIG. 2 illustrates an exploded perspective view of a plasma display panel according to an embodiment of the present invention;

FIG. 3 illustrates a cut-away view of discharge cells and electrodes shown in FIG. 2;

FIG. 4 illustrates a configuration of sub-pixels and pixels shown in FIG. 2;

FIG. 5 illustrates a schematic mechanism by which white light is produced in a white sub-pixel;

FIG. 6 illustrates a graph showing spectra of visible light produced in a white sub-pixel;

FIG. 7 illustrates an exploded perspective view of a plasma display panel according to another embodiment of the present invention;

FIG. 8 illustrates a configuration of discharge cells and electrodes shown in FIG. 7; and

FIG. 9 illustrates a configuration of sub-pixels and pixels shown in FIG. 7.

### DETAILED DESCRIPTION OF THE INVENTION

Korean Patent Application No. 10-2005-0002435, filed on Jan. 11, 2005, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A plasma display panel according to the present invention may include a discharge cell that generates white light. Accordingly, the brightness and luminous efficiency of the plasma display panel may be increased without increasing the percentage of Xe in the discharge gas.

A plasma display panel according to the present invention may also provide a plasma display panel having an electrode arrangement that enables high levels of visible light emission. In particular, visible light, radiated from discharge cells, may pass through a first substrate that does not have electrodes. Accordingly, the opening ratio and the transmissivity of the plasma display panel may be increased. Additionally, a plasma display panel according to the present invention may include discharge electrodes having low resistance, e.g., metal electrodes, instead of transparent electrodes, which may exhibit a high resistance. Accordingly, the discharge-response speed may be high, and the plasma display panel may be driven with a low voltage without distortion of an input waveform.

A plasma display panel according to the present invention may also provide for discharge to occur at sidewalls of a discharge cell and spread to the center of the discharge cell. Thus, the area where discharge occurs may be increased. Accordingly, the area of the discharge cell may be efficiently used, and the plasma display panel may be driven with a low voltage, thus improving the luminous efficiency.

A plasma display panel according to the present invention may also include first and second discharge electrodes formed on lateral sides of a discharge cell, such that an electric field created by the discharge electrodes concentrates plasma on the center of the discharge cell. Accordingly, even when the discharge continues for a long time, permanent images (burning in) due to damage to the phosphor by ion sputtering may be reduced or prevented.

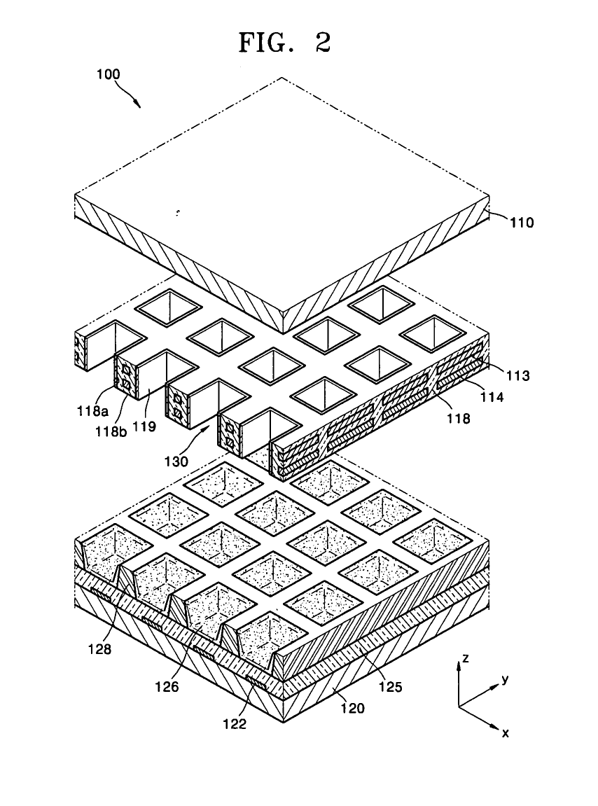

A plasma display panel 100 according to an embodiment of the present invention will now be described in detail with reference to FIGS. 2 through 6. The plasma display panel 100 may include a first substrate 110, a second substrate 120, first barrier ribs 118, first discharge electrodes 113, second discharge electrodes 114, second barrier ribs 128, address electrodes 122, phosphor layers 126, and a discharge gas. A discharge gas of, e.g., Ne, Xe, a mixture of Ne and Xe, etc., may be injected into discharge cells 130 defined by the barrier ribs and substrates.

The second substrate 120 may be disposed in parallel to the first substrate 110. Visible light produced in the plasma display panel 100 may be projected forward through the first substrate 110, i.e., in the z direction in the figures. Therefore, the first substrate 110 may be formed of a transparent material, e.g., glass. In other implementations, visible light may be emitted through the second substrate 120, or through both the first and second substrates 110 and 120, and the transparency of the materials used therefor may be selected accordingly.

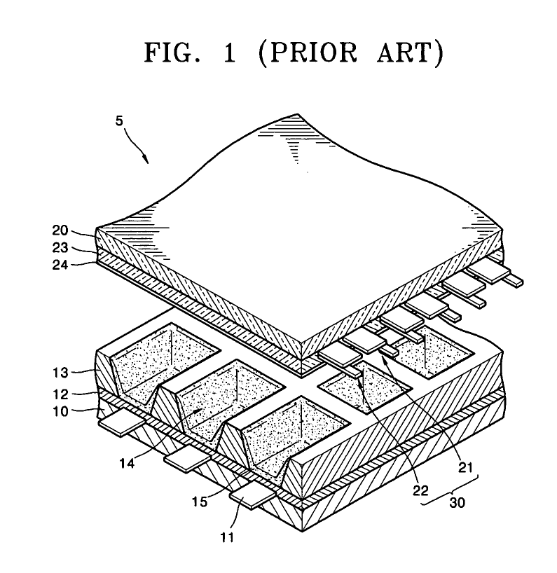

In contrast to the conventional plasma display panel 30 illustrated in FIG. 1, the plasma display panel 100 need not include sustain electrode pairs (element 30 in FIG. 1), or a dielectric layer (element 23 in FIG. 1) in which the sustain electrode pairs are buried, formed on the rear surface of the first substrate 110. Thus, the number of elements in front of the discharge cells 130 may be reduced. Hence, it may be possible to transmit 80% or more of the visible light emitted by the phosphor layers 126 through the first substrate 110.

The first barrier ribs 118, which define the discharge cells 130 in cooperation with the first and second substrates 110 and 120, may be arranged on the first substrate 110 so as to face the second substrate 120. The discharge cells 130 are illustrated in FIG. 2 arranged in a matrix. However, the present invention is not limited to this arrangement of the discharge cells 130, and they may be arranged in other suitable patterns, e.g., a delta configuration. Further, although the discharge cells 130 are illustrated as having a rectangular cross-sections in FIG. 2, the present invention is not so limited, and the cross-sections may be polygonal (e.g., triangular, pentagonal, etc.), circular, oval, etc.

The first and second discharge electrodes 113 and 114 may be disposed within the first barrier ribs 118 and may be arranged such that they are disposed apart from each other in the direction vertical to the first substrate 110 (i.e., the z direction). Sustain discharge, required by a plasma display panel to display an image, may occur between the first discharge electrodes 113 and the second discharge electrodes 114. The first and second discharge electrodes 113 and 114 may be formed of conductive material, e.g., a highly conductive metal such as, aluminum, copper, etc. The address electrodes 122 may be similarly formed of the same conductive material. The electrodes need not be transparent.

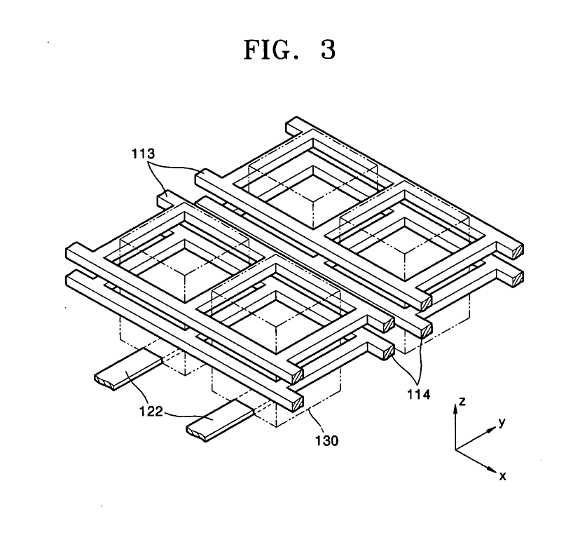

The first and second discharge electrodes 113 and 114 may both surround the discharge cells 130. Referring to FIG. 3, the first and second discharge electrodes 113 and 114 may have a ladder shape, such that they each surround a line of discharge cells 130, e.g., a line extending in the x direction in FIG. 3, and may include discharge cells between them. In particular, long members of the first and second discharge electrodes 113 and 114 may extend along the line of surrounded discharge cells 130, while short members of the members of the first and second discharge electrodes 113 and 114 may extend between the long members and bound individual discharge cells 130. An individual short member of the first and second discharge electrodes 113 and 114 may be common to adjacent discharge cells 130.

As illustrated in FIG. 2, and as detailed in the cut-away view in FIG. 3, the first and second discharge electrodes 113 and 114 may have ladder shapes arranged as in a first direction and the address electrodes 122 may be arranged in a second direction crossing the first direction, e.g., perpendicular to the first direction. The first discharge electrodes 113 may be paired with the second discharge electrodes 114, and the pairs may extend in parallel, e.g., in the x direction, while the address electrodes 122 may extend in, e.g., the y direction. This arrangement may enable address discharge to occur between one of the first and second discharge electrodes 113 and 114 and the address electrodes 122, and sustain discharge to occur between the first and second discharge electrodes 113 and 114.

In one discharge cell of a 3-electrode plasma display panel operable with address discharge and sustain discharge, two discharge electrodes (i.e., a discharge electrode pair), which are typically called an X electrode and a Y electrode, and a single address electrode may exist. Address discharge may occur between a Y electrode and an address electrode.

According to this embodiment of the present invention, when the address electrodes 122 are disposed to the rear of the first and second discharge electrodes 113 and 114, i.e., disposed apart from the first and second discharge electrodes 113 and 114 in the z direction, the second discharge electrodes 114, which are closer to the address electrodes 122, may be designated as Y electrodes to reduce an address discharge voltage. The first discharge electrodes 113 may be designated as X electrodes.

The first barrier ribs 118 may be formed of dielectric that can prevent direct conduction between adjacent first and second discharge electrodes 113 and 114 during sustain discharge and prevent damage to the first and second discharge electrodes 113 and 114 caused by the impact of charged particles. The barrier ribs 118 may be formed of dielectrics including, e.g., PbO, B₂O₃, SiO₂, etc.

Referring to FIG. 2, sidewalls 118a of the first barrier ribs 118, as well as other surfaces thereof, may be covered with protective layers 119. The protective layers 119 may be formed by, e.g., depositing a material such as MgO. The protective layers 119 may be formed on bottom sides 118b of the first barrier ribs 118 and a surface of the first substrate 110 facing the discharge cells 130.

According to the present invention, sustain discharge may occur primarily in front portions of the discharge cells 130, i.e., portions close to the first substrate 110. Thus, ion sputtering of phosphor due to charged particles produced during sustain discharge may be reduced, reducing the likelihood of a permanent image or burn in developing due to degradation of the phosphor layers 126.

As illustrated in FIGS. 2 and 3, the address electrodes 122 are arranged on the second substrate 120, which faces the first substrate 110. However, the present invention is not limited to the illustrated locations of the address electrodes 122. For example, the address electrodes 122 may be arranged within the first barrier ribs 118 to surround the discharge cells 130. In this case, the address electrodes 122 may have ladder shapes similar to the first and second discharge electrodes 113 and 114 while extending in a direction that crosses the direction in which the first and second discharge electrodes 113 and 114 extend. Further, the address electrodes 122 may be interposed between the first discharge electrodes 113 and the first substrate 110, between the first discharge electrodes 113 and the second discharge electrodes 114, or between the second discharge electrodes 114 and the second barrier ribs 128, so long as they are spaced apart from and insulated from the first and second discharge electrodes 113 and 114.

A dielectric layer 125 may also be included to prevent the address electrodes 122 from being damaged due to a collision of charged particles with the address electrodes 122 during discharge. In particular, the address electrodes 122 may be buried in the dielectric layer 125, i.e., surrounded thereby. The dielectric layer 125 may be formed of a dielectric material capable of inducing the charged particles. The dielectric layer 125 may include, e.g., PbO, B₂O₃, SiO₂, etc.

The plasma panel display 100 may include the second barrier ribs 128 disposed between the first barrier ribs 118 and the dielectric layer 125. The second barrier ribs 128 may define areas in which phosphor layers 126 are disposed. Similar to the first barrier ribs 118, the second barrier ribs 128 may be arranged in matrix, e.g., as a regular lattice defining spaces having substantially rectangular cross-sections.

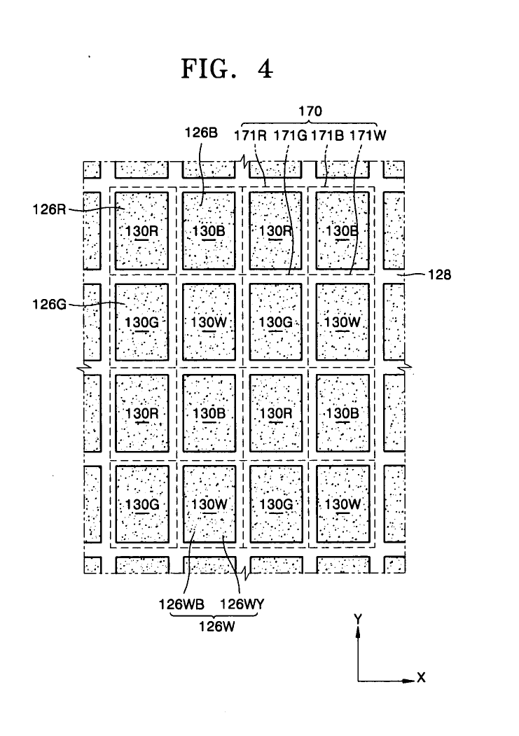

Referring to FIGS. 2 and 4, the phosphor layers 126 may correspond to the discharge cells 130. The phosphor layers 126 may include red, green, blue, and white phosphor layers 126R, 126G, 126B, and 126W, having a predetermined thickness. Red discharge cells 130R correspond to the red phosphor layers 126R, forming red sub-pixels 171R. Green discharge cells 130G correspond to the green phosphor layers 126G, forming green sub-pixels 171G. Blue discharge cells 130B correspond to the blue phosphor layers 126B, forming blue sub-pixels 171B. White discharge cells 130W correspond to the white phosphor layers 126W, forming white sub-pixels 171W.

The phosphor layers 126 may be formed on the sidewalls of the second barrier ribs 128 and on portions of the dielectric layer 125 exposed to the discharge cells 130. However the present invention is not so limited, and the phosphor layers 126 may be formed at various locations relative to the discharge cells 130.

Referring to FIG. 4, a pixel 170 may include four adjacent sub-pixels 171R, 171G, 171B, and 171W. The pixel 170, and the sub-pixels it includes, may have a rectangular shape, e.g., an oblong rectangle or a square shape. As illustrated in FIG. 4, the red, blue, white, and green sub-pixels 171R, 171B, 171W, and 171G of the pixel 170 are sequentially arranged in a circumferential direction with respect to the center of each pixel 170. However, the present invention is not limited to the illustrated arrangement.

The red phosphor layers 126R may include a phosphor such as Y(V,P)O₄:Eu, the green phosphor layers 126G may include a phosphor such as Zn₂SiO₄:Mn, and the blue phosphor layers 126B may include a phosphor such as a BAM-based phosphor, a CMS-based phosphor, etc. The BAM-based phosphor denotes a phosphor including Ba, Mg, and Al, such as BaMgAl₁₄O₂₃:Eu. The CMS-based phosphor denotes a phosphor including Ca, Ma, and silica, such as CaMaSi₂O₈:Eu²⁺.

When vacuum ultraviolet light generated by plasma discharge is incident upon the red phosphor layers 126W, red light is produced. When the vacuum ultraviolet light is incident upon the green phosphor layers 126G due to plasma discharge, green light is produced. When the vacuum ultraviolet light is incident upon the blue phosphor layers 126B due to plasma discharge, blue light is produced.

A white phosphor layer 128W may include a blue phosphor 128WB and a yellow phosphor 128WY. The blue phosphor 128WB and the yellow phosphor 128WY may be disposed at different locations within a white discharge cell, or may be mixed within the white discharge cell 130W, and the present invention is not limited to a particular way of disposing the blue and yellow phosphors 128WB and 128WY.

The blue phosphor 128WB produces blue light when receiving vacuum ultraviolet light. The blue phosphor 128WB may include, e.g., a BAM-based phosphor or a CMS-based phosphor. The yellow phosphor 128WY produces yellow light and may include, e.g., a YAG-based phosphor or a (Sr, Ba)SiO₄-based phosphor. The YAG-based phosphor denotes a phosphor that includes gadolinium in addition to yttrium and aluminum, while the (Sr, Ba)SiO₄-based phosphor includes Sr, Ba, and SiO₄. In particular, the yellow phosphor 128WY may be a YAG-based phosphor or a (Sr, Ba)SiO₄-based phosphor (e.g., SrBaSiO₄:Eu) that produces yellow light when receiving light having a wavelength of about 450 nm.

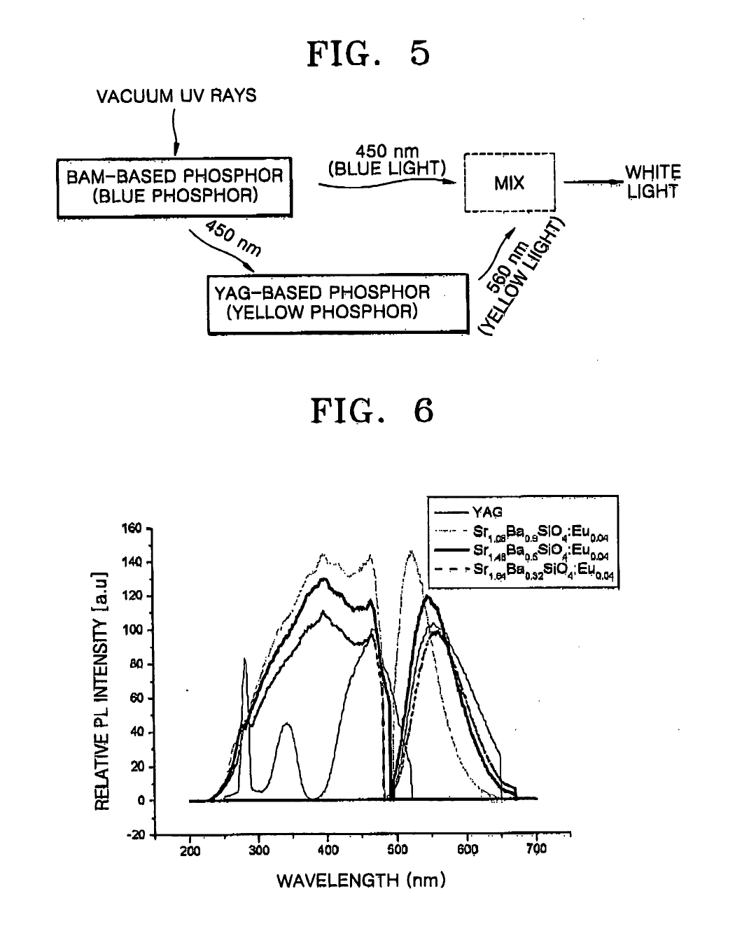

A mechanism by which white light may be produced in a white discharge cell 130W will now be described with reference to FIG. 5. Note that, although a BAM-based phosphor and a YAG-based phosphor are illustrated as the blue phosphor 126WB and the yellow phosphor 126WY, respectively, these examples are chosen for convenience and clarity of illustration. However, the present invention is not limited to these examples. When vacuum ultraviolet light is generated by plasma discharge and is incident upon the blue phosphor 126WB, the blue phosphor 126WB is excited. The energy level of the excited blue phosphor 126WB decreases by emission of blue light having a wavelength of about 450 nm. The emitted blue light may be incident upon the yellow phosphor 126WY, exciting it. In turn, the energy level of the excited yellow phosphor 126WY decreases by emission of yellow light having a wavelength of about 560 nm. The blue light and the yellow light have a complementary color relationship and mix within the white discharge cell 130W to produce white light. Thus, white light is emitted from the white discharge cell 130W.

FIG. 6 illustrates a graph showing spectra of visible light produced in a white sub-pixel. The spectra illustrate visible light produced in a variety of white sub-pixels 171W including different yellow phosphors. The spectra illustrate different yellow phosphors: a YAG-based phosphor and three (Sr, Ba)SiO₄-based phosphors, namely, Sr_{1.06}Ba_{0.9}SiO₄: Eu_{0.04}, Sr_{1.46}Ba_{0.5}SiO₄:Eu_{0.04}, and Sr_{1.64}Ba_{0.32}SiO₄:Eu_{0.04}. As shown in FIG. 6, blue light having a wavelength of about 450 nm and yellow light having a wavelength of about 560 nm exhibit the largest relative light-emission intensities. The blue light and the yellow light having such large relative light-emission intensities are mixed to produce white light.

In operation of the plasma display panel 100 having the above-described structure, address discharge may occur due to an application of an address voltage across the space between the address electrodes 122 and the second discharge electrodes 114, and consequently, a discharge cell 130 where sustain discharge is to occur is selected. Thereafter, a discharge sustain voltage may be applied across the space between a first discharge electrode 113 and a second discharge electrode 114 of the selected discharge cell 130, causing wall charges accumulated in the first and second discharge electrodes 113 and 114 to move, generating sustain discharge. The energy of the discharge gas excited during the sustain discharge may decreasing through the emission of vacuum ultraviolet light. The vacuum ultraviolet light excites the phosphor layers 126 corresponding to the discharge cells 130. Energy levels of the excited phosphor layers 126 decrease with the emission of visible light. The visible light exits the panel, e.g., by passing through the front substrate 110, generating an image that can be recognized by a viewer.

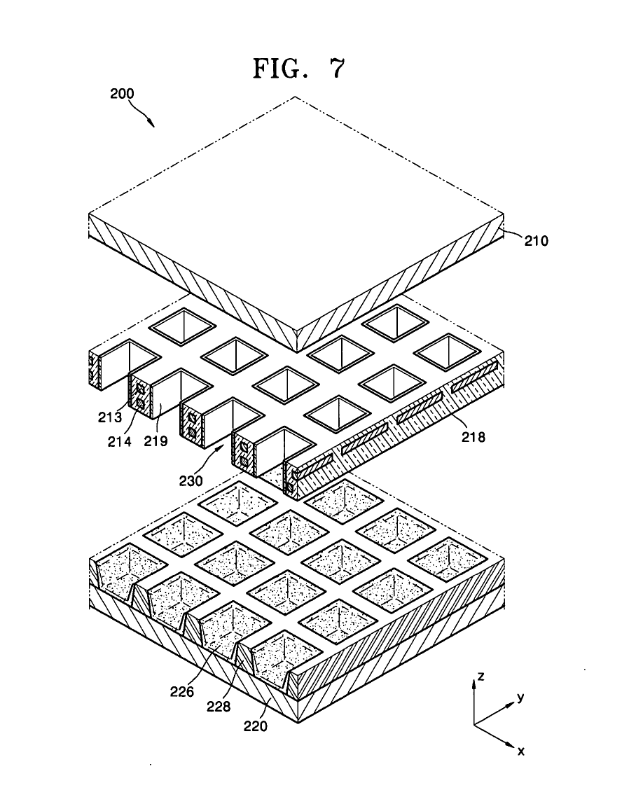

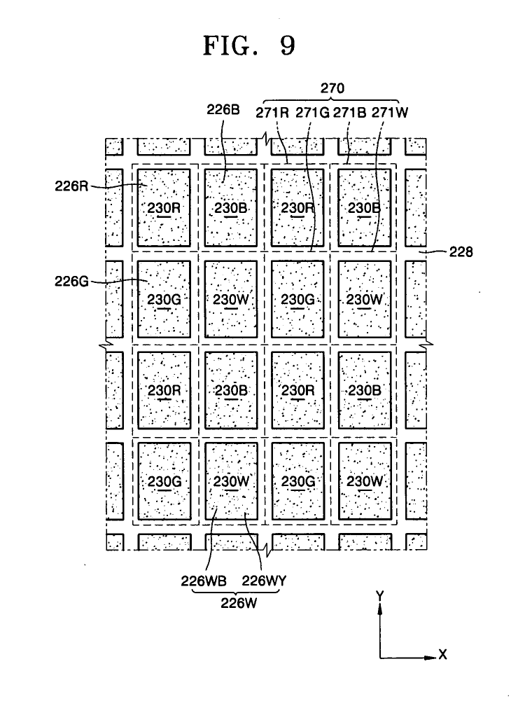

Another embodiment of the present invention will now be described with reference to FIGS. 7 through 9. The following description will focus on elements that are different from those described above in connection with the first embodiment and, in order to avoid repetition, a detailed explanation of the other features will not be repeated.

Referring to FIGS. 7 through 9, a plasma display panel 200 may include a first substrate 210, a second substrate 220, first barrier ribs 218, second barrier ribs 228, protective layers 219, and a discharge gas. The plasma display panel 200 may not include address electrodes, and first discharge electrodes 213 and second discharge electrodes 214 may extend in different directions so as to cross each other.

In particular, the first discharge electrodes 213 may extend in one direction, e.g., in the x direction, while the second discharge electrodes 214 may extend in a direction intersecting the first discharge electrodes 213, e.g., in the y direction. The intersecting first and second discharge electrodes 213 and 214 may be used to generate address discharge and sustain discharge in discharge cells 230. That is, one of the first discharge electrodes 213 and the second discharge electrodes 214 may serve as address electrodes, and the other may serve as scanning electrodes.

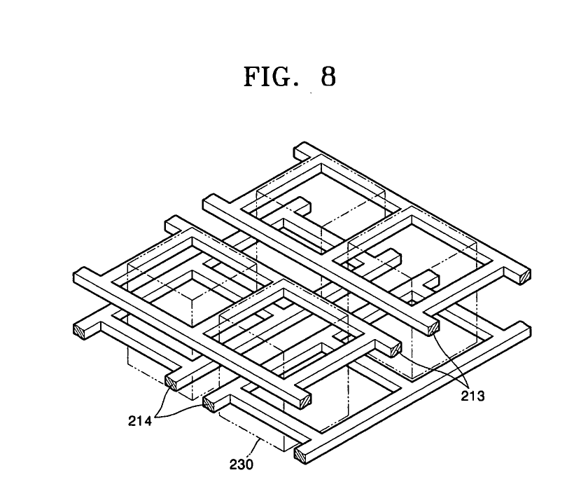

The first discharge electrodes 213 and the second discharge electrodes 214 may have ladder shapes and may surround the discharge cells 230. Referring to FIG. 8, long members of the first discharge electrodes 213 may extend in a direction perpendicular to long members of the second discharge electrodes 214. The materials of the first and second discharge electrodes 213 and 214 may be similar to those described above in connection with the previous embodiment.

Red, green, blue, and white discharge cells 230R, 230G, 230B, and 230W correspond to red, green, blue, and white phosphor layers 226R, 226G, 226B, and 226W, forming red, green, blue, and white sub-pixels 271R, 271G, 271B, and 271W, respectively. Pixels 270 may each have a rectangular shape, e.g., a square shape, and include red, green, blue, and white sub-pixels 271R, 271G, 271B, and 271W. A yellow phosphor 226WY and a blue phosphor 226WB may be disposed in the white discharge cell 230W corresponding to the white sub-pixel 271W. Since structures and operations of the yellow and blue phosphors 226WY and 226WB are similar to those described above in connection with the previous embodiment, a detailed description thereof will not be repeated. Likewise, the red, green, blue, and white phosphor layers 226R, 226G, 226B, and 226W and the mechanism by which white light is produced in a white discharge cell 230W may also be similar to those described above.

In operation of the plasma display panel 200, address discharge may occur due to an application of an address voltage across the space between the first discharge electrodes 213 and the second discharge electrodes 214, and consequently, a discharge cell 230 where sustain discharge is to occur is selected. When a discharge sustain voltage is applied to the space between the first discharge electrode 213 and the second discharge electrode 214 of the selected discharge cell 230, wall charges accumulated in the first and second discharge electrodes 213 and 214 move, generating sustain discharge. An energy level of the discharge gas, excited during the sustain discharge, decreases with the emission of vacuum ultraviolet light. The vacuum ultraviolet light excites phosphor layers 226 formed in the discharge cells 230 and, as energy levels of the excited phosphor layers 226 decrease, visible light is emitted. The visible light exits the plasma display panel 200 by, e.g., passing through the front substrate 210, so that an image that can be recognized by a viewer is formed. Accordingly, a plasma display panel having improved brightness may be obtained.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel comprising a plurality of pixels, wherein:
each pixel includes a white sub-pixel; and
the white sub-pixel includes a white phosphor layer.

2. The plasma display panel as claimed in claim 1, wherein the white phosphor layer includes a blue phosphor and a yellow phosphor.

3. The plasma display panel as claimed in claim 2, wherein the blue phosphor includes at least one of a BAM-based phosphor and a CMS-based phosphor.

4. The plasma display panel as claimed in claim 2, wherein the yellow phosphor includes at least one of a YAG-based phosphor and a (Sr, Ba)SiO₄-based phosphor.

5. The plasma display panel as claimed in claim 1, wherein each pixel further includes a red sub-pixel, a green sub-pixel, and a blue sub-pixel.

6. The plasma display panel as claimed in claim 5, wherein each of the sub-pixels has a substantially rectangular shape.

7. The plasma display panel as claimed in claim 6, wherein each of the sub-pixels is square, and the sub-pixels are arranged in a square.

8. The plasma display panel as claimed in claim 5, further comprising first and second electrodes, wherein each of the first and second electrodes encircles each sub-pixel.

9. The plasma display panel as claimed in claim 8, wherein:
each of the first and second electrodes has a ladder shape and includes two long members and a plurality of short members, the short members spaced apart from each other and disposed between the two long members, and
each sub-pixel is bounded by the two long members and two short members.

10. The plasma display panel as claimed in claim 9, wherein adjacent sub-pixels are bounded by a common short member.

11. The plasma display panel as claimed in claim 5, further comprising:
a first substrate and a second substrate spaced apart from each other and facing each other;
first barrier ribs disposed between the first and second substrates and defining at least four discharge cells corresponding to the red sub-pixel, the green sub-pixel, the blue sub-pixel, and the white sub-pixel; and
first and second electrodes.

12. The plasma display panel as claimed in claim 11, wherein each of the first and second electrodes extends to surround the discharge cells.

13. The plasma display panel as claimed in claim 12, wherein each of the first and second electrodes has a ladder shape.

14. The plasma display panel as claimed in claim 11, wherein the first and second electrodes are disposed in the first barrier ribs.

15. The plasma display panel as claimed in claim 11, further comprising protective layers formed on sidewalls of the first barrier ribs.

16. The plasma display panel as claimed in claim 11, wherein the first electrodes extend in a first direction, and the second electrodes extend in a second direction crossing the first direction.

17. The plasma display panel as claimed in claim 11, wherein the first and second electrodes extend parallel to each other in a first direction, and wherein address electrodes extend in a second direction crossing the first and second electrodes.

18. The plasma display panel as claimed in claim 11, further comprising second barrier ribs disposed on the second substrate and between the first barrier ribs and the second substrate.

19. The plasma display panel as claimed in claim 18, wherein portions of the second barrier ribs are coated with red, green, blue, and white phosphor layers corresponding to the red, green, blue and white sub-pixels.

20. The plasma display panel as claimed in claim 1, wherein the pixels have square shapes.
